(19) United States
(12) Patent Application Publication
(10) Pub. No.: US 2015/0121177 A1
(43) Pub. Date: Apr. 30, 2015

(54) ELECTRONIC DEVICE, METHOD, AND STORAGE MEDIUM

(71) Applicant: Kabushiki kaisha Toshiba, Tokyo (JP)

(72) Inventors: Takayuki Iida, Tachikawa-shi (JP); Makito Ogura, Hino-shi (JP); Kensuke Horiuchi, Kunitachi-shi (JP)

(73) Assignee: Kabushiki Kaisha Toshiba, Tokyo (JP)

(21) Appl. No.: 14/262,458

(22) Filed: Apr. 25, 2014

(30) Foreign Application Priority Data
Oct. 30, 2013 (JP) 2013-225226

(51) Int. Cl. G06F 3/0483; G06F 3/0482; G06F 17/21; G06F 3/0484

(52) U.S. Cl. CPC G06F 3/0483; G06F 3/04847; G06F 3/0482; G06F 17/212
USPC 715/201

(57) ABSTRACT

According to one embodiment, an electronic device includes a receiver configured to receive data of an electronic book, and a display controller configured to display a slider, and to display a designated page in response to a designation by the slider. The display controller is configured to display a first thumbnail in accordance with a first position corresponding to the first page, the first thumbnail including at least one of a part of first information, relating to the first page, included in a page of a table of contents and second information of an illustration of the first page or a page close to the first page.

### CROSS-REFERENCE TO RELATED APPLICATIONS

This application is based upon and claims the benefit of priority from Japanese Patent Application No. 2013-225226, filed Oct. 30, 2013, the entire contents of which are incorporated herein by reference.

### FIELD

Embodiments described herein relate generally to an electronic device, a method, and a storage medium for reading electronic books.

### BACKGROUND

In recent years, electronic devices for downloading (purchasing) electronic books via the Internet and reading them have begun to spread. The electronic devices may be dedicated electronic book viewers, or general-purpose tablet computers, smartphones, and notebook computers that execute an application program for reading electronic books.

Generally, cover image data is attached to each of electronic books, and a list of purchased electronic books can be displayed on the screen with the image data. The user selects the cover image of a book to be read from the cover images displayed as a list on the screen, and starts to read the target electronic book. The user can turn the pages of the book by operating a software button displayed on the screen or a hardware button provided on the device.

Conventional electronic book viewers are not regarded as providing the user with useful information, when the user performs a page jump operation to read another desired page while reading the electronic book.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIGS. 1A, 1B, and 1C illustrate an example of an external appearance of an embodiment of an electronic device.

FIG. 2 is a diagram illustrating an example of a system configuration of the embodiment of the electronic device.

FIG. 3 is a diagram illustrating an example of a configuration of a book viewer according to the embodiment of the electronic device.

FIG. 4 is a diagram illustrating an example of slider display according to the embodiment of the electronic device.

FIG. 5 is a flowchart illustrating an example of operation according to the embodiment of the electronic device.

FIG. 6 is a diagram illustrating an example of a structure of a book viewer according to a second embodiment of the electronic device.

FIGS. 7A and 7B illustrate an example of slider display according to the second embodiment of the electronic device.

FIGS. 8A and 8B illustrate another example of slider display according to the second embodiment of the electronic device.

FIG. 9 is a diagram illustrating an example of a structure of a book viewer according to a third embodiment of the electronic device.

FIGS. 10A and 10B illustrate an example of slider display according to a third embodiment of the electronic device.

### DETAILED DESCRIPTION

Various embodiments will be described hereinafter with reference to the accompanying drawings.

In general, according to one embodiment, an electronic device includes a receiver configured to receive data of an electronic book comprising pages, and a display controller configured to display a slider for designating one of pages in the electronic book, and to display a designated page in response to a designation by the slider. The display controller is configured to further display a first thumbnail in accordance with a first position corresponding to the first page on the slider, the first thumbnail comprising at least one of a part of first information, relating to the first page, included in a page of a table of contents and second information of an illustration of the first page or a page close to the first page.

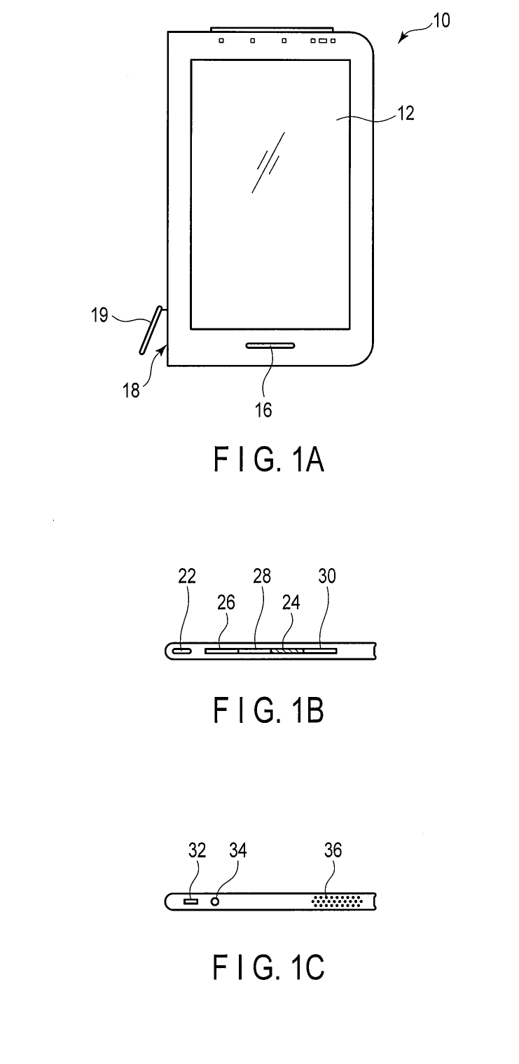

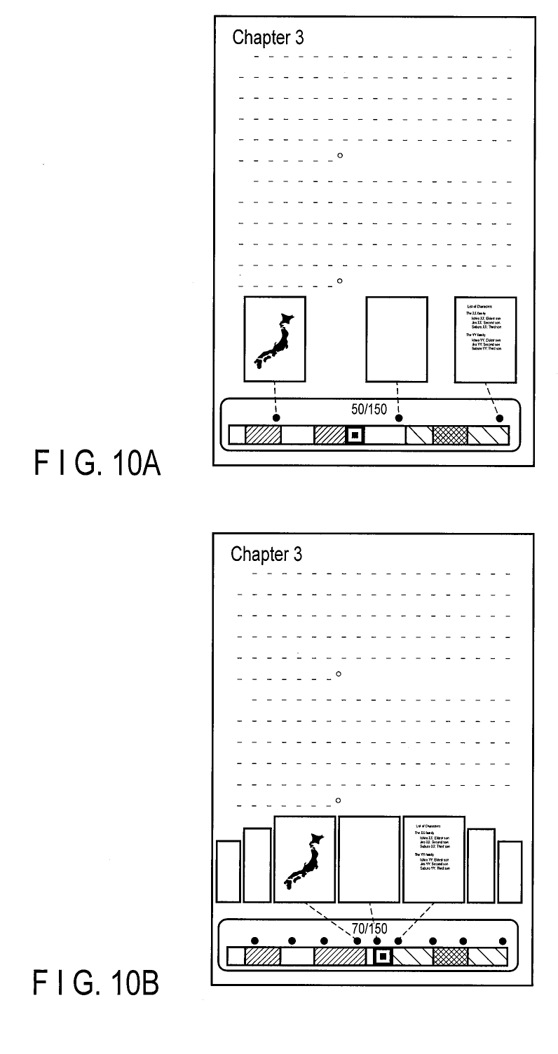

FIGS. 1A, 1B, and 10 illustrate an external appearance of an electronic device 10 according to an embodiment. In the embodiment, the electronic device 10 is produced as a dedicated portable device to download and read electronic books via the Internet. The term “dedicated device” means that the device is provided with operating buttons as hardware buttons. However, the electronic device 10 need not be a dedicated device, but a general-purpose tablet computer, a smartphone, or a notebook computer that executes an application program for reading electronic books. FIG. 1A is a front view of the electronic device 10, FIG. 1B is a top view of the electronic device 10, and FIG. 10 is a bottom view of the electronic device 10.

The electronic device 10 is flat, like a tablet computer. As illustrated in FIG. 1A, a touchpanel display 12 is provided in a central part of a front surface of a housing of the device. A home button 16 serving as one of various operating buttons is provided in a part surrounding the touchpanel display 12 and being a lower part of the front surface of the housing. The home button 16 is a button to change the display picture on the touchpanel display 12 to an initial picture. A side surface (a left side surface as viewed from the front) of the housing is provided with a slot 18 to receive, for example, a Micro SD (Secure Digital) card (registered trademark). The slot 18 is covered with a cover 19 attached to the main body. The electronic device 10 has a wireless communication function using Wi-Fi or the like. The wireless communication function enables the user to purchase electronic books, that is, download them over the Internet.

As illustrated in FIG. 1B, the electronic device 10 is provided with a power button 22, a reading button 24, and other buttons 26, 28, and 30 serving as operating buttons, on an upper surface of the housing. The user turns on and off the power of the electronic device, by operating the power button 22. The reading button 24 is a button for reading. The operation performed when the reading button 24 is operated will be described below. For example, the buttons 26 and 28 may be a previous-page button and a next-page button, respectively, to turn the page being read. The previous-page button and the next-page button may not be dedicated hardware buttons, but software buttons displayed on the screen. The page-turning operation may not be a button operation, but a flick operation on the touchpanel display 12.

As illustrated in FIG. 1C, the electronic device 10 is provided with a micro USB connector 32 to connect a USB (Universal Serial Bus) cable, a headphone jack 34 to connect a headphone, and a speaker 36, in a bottom surface of the housing thereof.

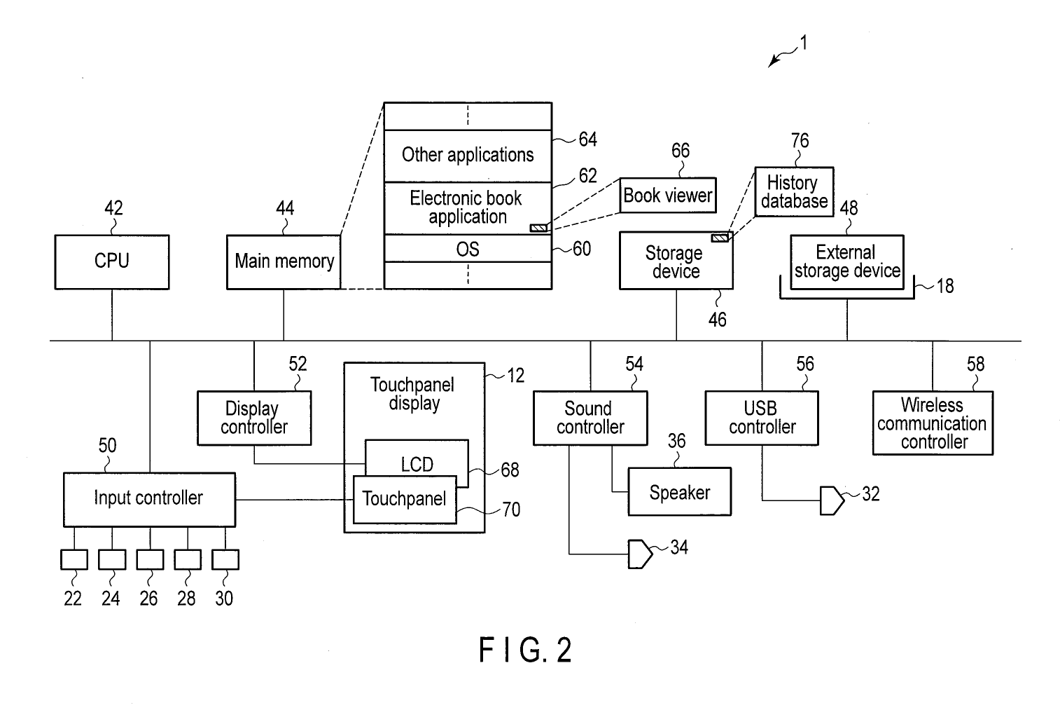

FIG. 2 is a diagram illustrating a system configuration of the electronic device 10. The electronic device 10 includes a CPU (Central Processing Unit) 42, a main memory 44, a storage device 46, an external storage device 48, an input controller 50, a display controller 52, the touchpanel display 12, a sound controller 54, the speaker 36, a USB controller 56, a wireless communication controller 58, and the like.

The CPU 42 is a processor that controls operation of the whole electronic device 10. For example, the CPU 42 loads various programs from the storage device 46 formed of an SSD (Solid-State Drive) or the like into the main memory 44, and executes the programs. The storage device 46 also stores electronic books downloaded over the Internet. The external storage device 48 is a Micro SD card (registered trademark) contained in the slot 18 illustrated in FIG. 1A. Although the external storage device 48 is contained in the slot 18 mainly for the purpose of expanding a memory region for storing electronic books, the CPU 42 can load the program stored in the external storage device 48 into the main memory 44, and execute the program.

The various programs executed by the CPU 42 include an OS (Operating system) 60 that manages resources, an electronic book application program 62 described below and other application programs 64 that operate under the OS 60. The electronic book application program 62 includes a book viewer 66 serving as a program module for reading electronic books. Although the present embodiment shows an example in which the book viewer 66 exists as a module of the electronic book application program 62, the book viewer 66 may be mounted as a program (one of the other application programs 64) separate from the electronic book application program 62.

The input controller 50 is a controller to control data inputs performed by touch operations on the touchpanel display 12, and data inputs performed by operations of a variety of operating buttons 22, 24, 26, 28, and 30. The touchpanel display 12 includes an LCD (Liquid crystal display) 68 and a touchpanel 70. When a touch operation is performed on the touchpanel display 12, input information including the position on the touchpanel 70 is output from the touchpanel 70 to the input controller 50. The input controller 50 stores the input information in its own register, notifies the CPU 42 thereof by generating an interrupt, and causes the CPU 42 to read the input information stored in the register. Thereby, the OS 60 is notified of occurrence of an event being a touch operation on the touchpanel display 12.

In the same manner, when one of the operating buttons 22, 24, 26, 28, and 30 is operated, the input controller 50 stores the input information in its own register, notifies the CPU 42 thereof by generating an interrupt, and causes the CPU 42 to read the input information stored in the register. Thereby, the OS 60 is notified of occurrence of an event being an operation of one of the operating buttons 22, 24, 26, 28, and 30.

The OS 60 notifies the electronic book application program 62 and the other application programs 64 of occurrence of the notified event.

On the other hand, the display controller 52 controls picture display on the LCD 68 included in the touchpanel display 12. The display controller 52 is equipped with an accelerator that draws a picture to be displayed by the various programs, instead of the CPU 42.

The sound controller 54 is a sound-source device. The sound controller 54 generates a sound signal corresponding to the audio data to be played back, and outputs the sound signal to the speaker 36. When a headphone is connected to the headphone jack 34, the sound controller 54 switches the output destination of the sound signal to the headphone jack 34.

The USB controller 56 manages communications with a USB device connected via the micro-USB connector 32. The wireless communication controller 58 controls wireless communications.

The following is explanation of a reading function executed by the electronic book application program 62 (in particular, the book viewer 66) operating on the electronic device 10 having the above structure.

The electronic book application program 62 has a function of purchasing (downloading) electronic books via the Internet.

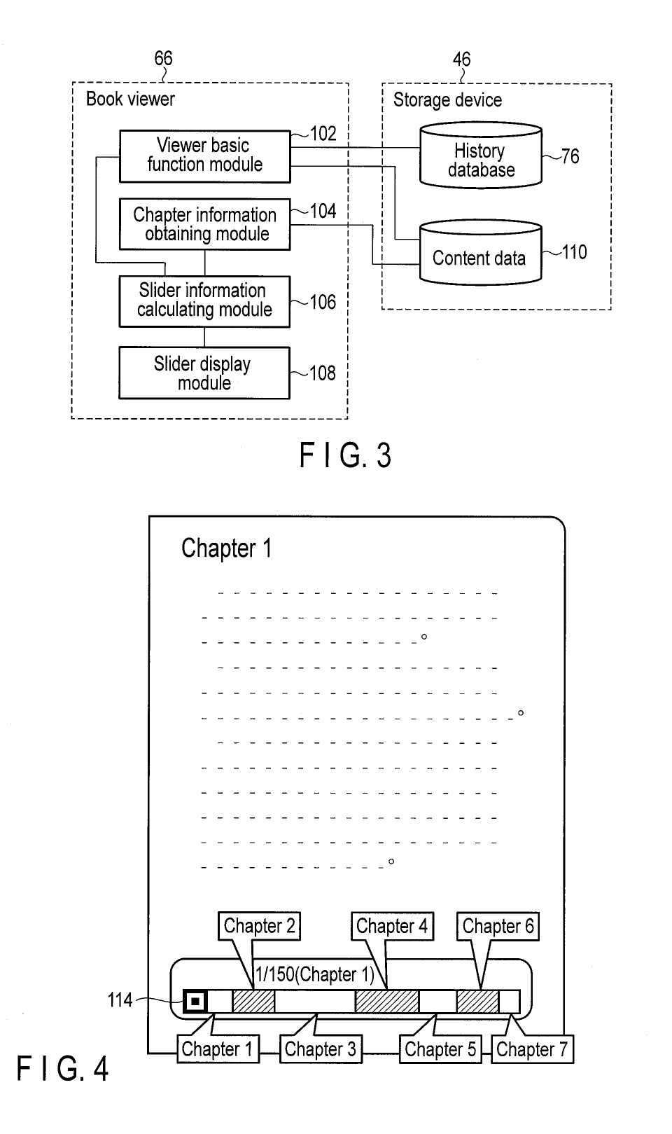

FIG. 3 is a diagram illustrating an example of functional blocks of the book viewer 66. The book viewer 66 includes a viewer basic function module 102, a chapter information obtaining module 104, a slider information calculating module 106, and a slider display module 108. The viewer basic function module 102 and the chapter information obtaining module 104 are connected to electronic book data (content data) 110 stored in the storage device 46.

Operation of the viewer basic function module 102 will now be explained. The viewer basic function module 102 has a function of displaying a list of purchased electronic books, and a function of reading an electronic book.

The user can start the book viewer 66, by pressing down (short press) the reading button 24 in a state where any picture is displayed on the touchpanel display 16. The viewer basic function module 102 of the book viewer 66 started by short press loads the book, reading of which was suspended in the last reading, and displays a picture of the page, reading of which was suspended in the last reading. The term “short press” means pressing the button for a time less than a threshold value. The user can also start the book viewer 66, by pressing down (long press) the reading button 24 in a state where any picture is displayed on the touchpanel display 16. The viewer basic function module 102 of the book viewer 66 started by long press can read a reading history from a history database 76 provided in the storage device 46, and display a list of the reading history. The term “long press” means pressing the button for a time exceeding the threshold value. The list of the reading history is displayed, for example, in the order of date on which information of the book was suspended (for example, the book suspended on the latest date comes first).

When reading is suspended, the user can store suspension information by pressing down a bookmark button (software button displayed on the touchpanel display 16). When the viewer basic function module 102 is notified by the OS 60 of occurrence of an event (suspension request event) of a touch operation on the position where the bookmark button is displayed, the viewer basic function module 102 registers identification information (book ID), suspended position (page) information, and the reading start date of the opened book in the history database 76. Reading is also suspended when the picture is jumped to a picture other than the book viewer 66 by operation of pressing down the home button 16 or the like. Also in this case, suspension information can be stored in the history database 76.

Next, operation of the book viewer 66 other than the viewer basic function module 102 will be explained hereinafter.

The chapter information obtaining module 104 obtains chapter information (or episode number information) from a table of contents or index information of the electronic book, when content data 110 is read from the storage device 46. The slider information calculating module 106 calculates, for each chapter, which pages correspond to the chapter, based on the character size of the electronic book being read by the viewer basic function module 102. This is because the number of pages may depend on the display character size. The target electronic book may be a novel or a comic, as long as it holds chapter information. The term “chapter” indicates a rough division for an electronic book, and an electronic book may be divided into “episodes”, not “chapters”. The slider information calculating module 106 also obtains total page information and current page information of the electronic book from the viewer basic function module 102. A calculation result of the slider information calculating module 106 is supplied to the slider display module 108. The slider display module 108 indicates which part of the whole book includes the currently displayed page, and displays a slider to perform page jump operation. The slider is formed of a bar-shaped mark (hereinafter referred to as a “slider bar”) that indicates the whole electronic book, and a displayed page icon displayed in a position of the displayed page in the slider bar. The slider is displayed in any space in one of the upper part, the lower part, the left part, and the right part of the picture. The displayed page icon is slid along the slider bar, and thereby the user can jump to the page located in the position of the displayed page icon.

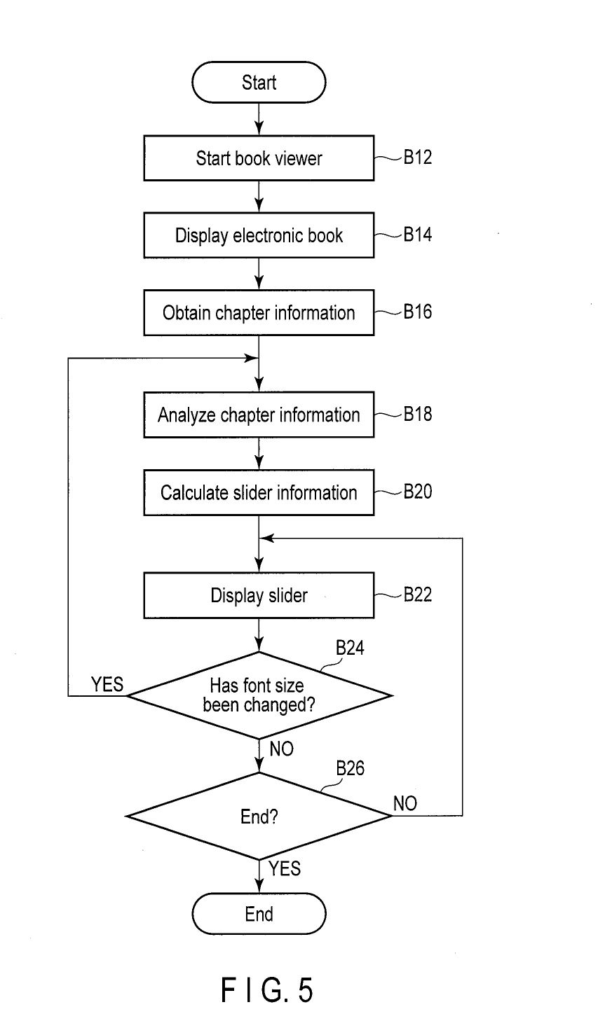

FIG. 4 illustrates an example of the slider. FIG. 4 illustrates an example of reading an electronic book that includes seven chapters. In the present embodiment, the slider bar is displayed in different forms for respective chapters, for example, with different background colors or gradations. FIG. 4 shows the case of adopting an electronic device including a monochrome display such as electronic paper, and chapters of the slider bar are displayed with alternate colors of black and white. In the case of adopting a device including a color display, a plurality of colors or gradations may be used to more clearly display the chapters. The balloons (illustrating chapters) in FIG. 4 are illustrated for the sake of convenience of explanation, and are not displayed on the actual screen. The slider also includes the current page number/total page number, and chapter information (characters indicating which chapter includes the displayed page). Display of the chapter information may be omitted, when the slider bar is displayed in different forms for the respective chapters. A displayed page icon 114 is displayed in a position in the slider bar, which corresponds to a position of the displayed page. Since page 1 (chapter 1) is displayed in the example of FIG. 4, the displayed page icon 114 is displayed in the left end part of the slider bar. Since the slider bar is displayed in different forms for the respective chapters, the slide position can be easily adjusted when the displayed page icon 114 is slid along the slider bar, and the user can easily jump to a page of the desired chapter. Page jump operation can be more easily performed, when the chapter information is also displayed. A scale formed of a line with divisions of chapters may be displayed instead of the bar.

FIG. 5 is a flowchart illustrating the above operations according to the first embodiment. When the book viewer 66 is started in Block B12, the viewer basic function module 102 displays an image of an electronic book in Block B14. The electronic book may be a book, reading of which was suspended last, a book selected from the history list, or a book selected from a list of unread books. The font size can be changed as desired by pinch-in and/or pinch-out operations performed on the touchpanel display 12.

In Block B16, the chapter information obtaining module 104 obtains chapter information (or episode number information), from a table of contents or index information of the displayed electronic book. In the example of FIG. 4, the chapter information obtaining module 104 obtains information that “the electronic book has seven chapters”. In Block B18, the chapter information is analyzed, and the starting page of each chapter is obtained. The font size of the displayed electronic book is also referred to, to analyze the chapter information. This is because electronic books formed of characters include electronic books, layout (the number of characters in a page) of which is changed with change in the font size. In this case, the starting page number of each chapter changes according to the font size.

In Block B20, the slider information calculating module 106 divides the slider bar according to the chapter information, and determines the display forms that are different between the chapters. The slider information calculating module 106 also determines the display position of the displayed page icon 114 based on the current page information. In Block B22, the slider display module 108 displays the slider in a space of the electronic book, for example, a space in the lower part of the electronic book.

In Block 24, it is determined whether the font size has been changed or not. When the font size has been changed, the total number of pages of the electronic book is changed. Thus, chapter information is analyzed again in Block B18, and the starting page of each chapter is changed. When the font size has not been changed, it is determined in Block B26 whether reading of the electronic book is ended or not. If reading is not ended, the process returns to Block B22, and the slider display is continued.

According to the first embodiment as described above, the chapter information of the electronic book is also displayed on the slider, as well as the current displayed page for the total number of pages of the electronic book, and the position corresponding to the displayed page. This structure enables display of supplementary information to support jump operation to the target page, when the user performs page jump operation while reading the electronic book. The above structure also has the effect that the page jump operation can be easily performed, since the user can understand a rough position of the current page based on the slider display.

Next, another embodiment will be explained hereinafter. The embodiment relates to a modification of the function of the book viewer 66. The embodiment has the external appearance illustrated in FIG. 1 and the system configuration illustrated in FIG. 2, like the first embodiment.

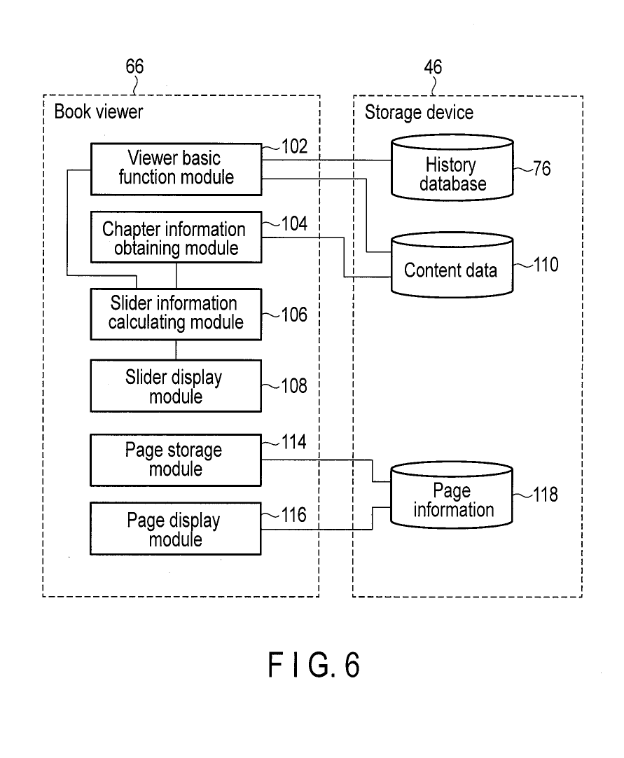

FIG. 6 is a diagram illustrating an example of functional blocks of a book viewer 66 according to the second embodiment. The book viewer 66 includes a page storage module 114 and a page display module 116, in addition to the functional blocks illustrated in FIG. 3.

The second embodiment enables the user to perform operation to store a page (for example, a list of the characters in the novel, or a page of an illustration such as a map) which the user wishes to read again later, when the page is displayed. The operation for storing the page includes a long press of the picture, double tapping, or a press down of a dedicated button. For example, the dedicated button may be the hardware button 30, or a software button displayed on the screen. When the storing operation is performed, the page storage module 114 stores image information (page information) 118 of the displayed page in the storage device 46.

Thereafter, when the user wishes to read the stored page again while reading another page, the user performs a specific operation to read the stored page information 118 from the storage device 46, and can display the page on the screen. The specific operation for displaying the stored page information includes a long press of the picture, double tapping, or a press down of the dedicated button, but is different from the operation for storing the page.

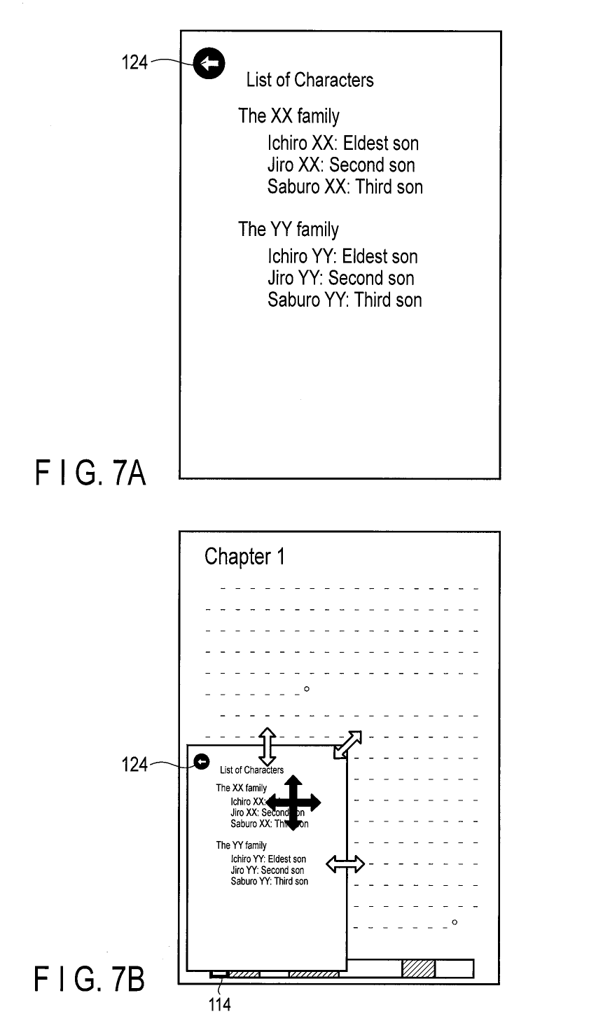

When the stored page information is displayed, the stored page can be displayed on the whole screen as illustrated in FIG. 7A, or may be displayed in a window in another page as illustrated in FIG. 7B. When the stored page is displayed on the whole screen as illustrated in FIG. 7A, the stored page and the current page may be switchable to each other by tabs, as in a tab browser. When the stored page is displayed in a window form as illustrated in FIG. 7B, the display position is a lower left part of the screen in the initial state, and the window may be moved or enlarged to improve the operability.

It is also possible to remove the display of the stored page. When the user wishes to return the device to its original reading state, the user performs an operation for removing the displayed page. The operation for removing the displayed page includes tapping on the screen or a press down of the dedicated button (a Back button 124), but is different from the operation for storing the page and the operation for displaying the stored page.

A plurality of pages (a certain upper limit is provided in consideration of the storage capacity) can be stored in the storage device 46. When the number of the stored pages reaches the upper limit, the stored pages may be automatically deleted from the oldest page, or the page selected by the user by means of the user interface may be deleted.

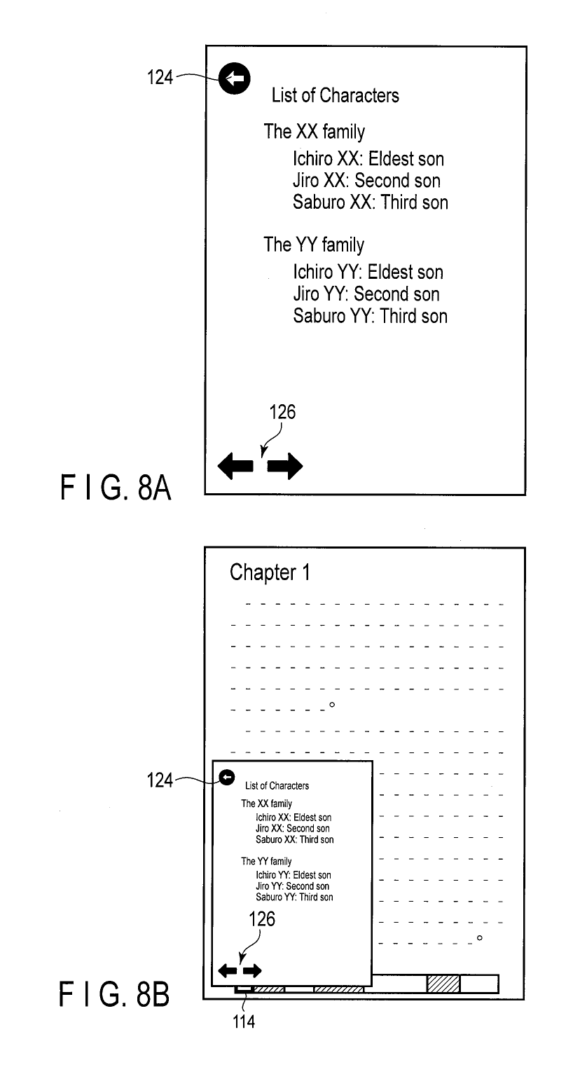

When the storage device 46 stores a plurality of pages, a user interface (a left/right button 126) that enables successive display of the pages may be provided as shown in FIGS. 8A and 8B, or the pages may be successively displayed by repeating a specific operation (for example, successively performing double-tapping operations).

According to the second embodiment, when a page (for example, a list of the characters in the novel, or a page of an illustration such as a map) which the user wishes to read again later is displayed in reading, the page can be stored by a simple operation, and read and displayed later by a simple operation. Thus, the second embodiment enables the user to read a specific page again by a simple operation, and improves the convenience in reading electronic books.

In the second embodiment, slider display is not indispensable, and the book viewer 66 may be formed of a viewer basic function module 102, the page storage module 114, and the page display module 116.

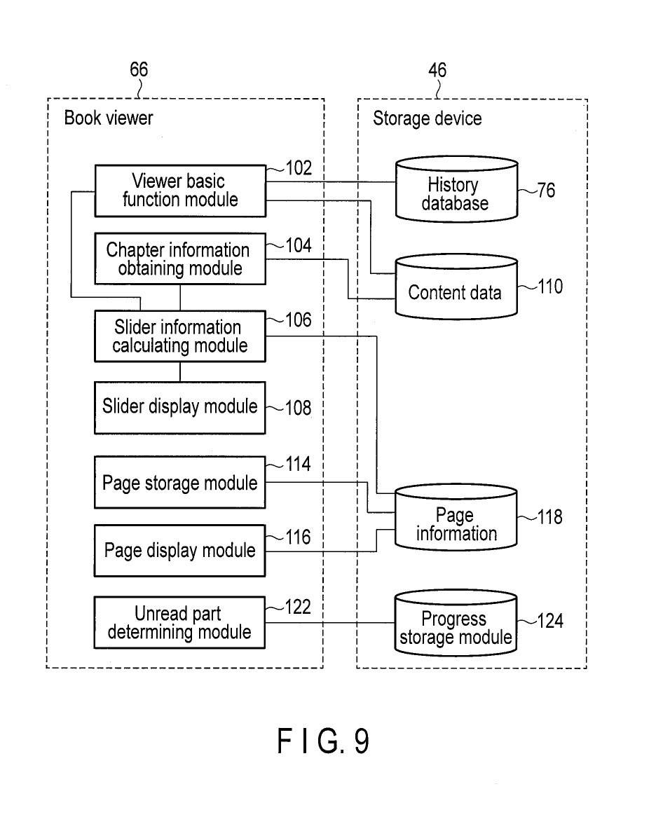

FIG. 9 is a diagram illustrating an example of functional blocks of a book viewer 66 according to a third embodiment. The book viewer 66 of the third embodiment includes an unread part determining module 122, in addition to the functional blocks illustrated in FIG. 6. According to the third embodiment, the book viewer 66 analyzes the electronic book to extract characteristic pages, in addition to storage of a specific page performed by a user's operation. The slider additionally displays thumbnails of the stored pages and the extracted pages.

A chapter information obtaining module 104 of the book viewer 66 also obtains file structure information and tag information (such as an <img> tag and a <table> tag) from a table of contents and index information of the displayed electronic book. A slider information calculating module 106 analyzes the electronic book based on the file structure information and the tag information (such as an <img> tag and a <table> tag), and extracts characteristic pages (such as illustration pages of the novel, table data, and graph data). The characteristic pages are pages that are considered to be probably referred to while the electronic book is read, or pages that are considered to improve the user's convenience when referred to.

The slider information calculating module 106 prepares thumbnails of page information 118 stored by the page storage module 114 and the extracted characteristic pages. When the slider is displayed as illustrated in FIGS. 10A and 10B, the slider display module 108 also displays thumbnails of the characteristic pages and the pages stored by the user above the slider.

The slider display module 108 also displays dots in upper parts of the slider bar that correspond to the relevant pages of the thumbnails, and displays dotted lines connecting the respective dots with the respective thumbnails. The display of dotted lines may be omitted, when correspondence between the thumbnails and the relevant pages can be easily understood. The user can directly jump to a page, by tapping the thumbnail of the page. It may be changed by setting as to whether the extracted characteristic pages are displayed to be distinguished from the pages stored by the user. The display form to distinguish them may be changed by setting.

FIG. 10A illustrates the case where the number of thumbnails is relatively small, and all the thumbnails can be displayed together in the same size. In the case where the number of thumbnails is large and all the pages cannot be displayed together, thumbnails of pages close to the current page are displayed in an ordinary size, and the other thumbnails are displayed in a reduced size, or display of them may be omitted, as illustrated in FIG. 10B. In the example of FIG. 10B, thumbnails of page 70 and the following pages may not be displayed.

According to the contents of the electronic book, display of thumbnails of the unread parts undesirably tells the user how the story is developed hereafter. Thus, thumbnails to be displayed should be limited according to the progress of the user's reading. For example, suppose that the user has read the electronic book up to page 100, in the electronic book with 200 pages in total. In this case, the unread part determining module 122 determines which parts of the electronic book are unread or have been read, and thumbnails of the unread parts may not be displayed, although thumbnails of parts up to page 100 are displayed. This function can be turned on and off by setting by the user.

According to the third embodiment, thumbnails of the pages stored by the user and the characteristic pages such as illustration pages are displayed together above the slider. The thumbnails serve as a guide for page jump operations, and enable the user to easily jump to the desired page. The thumbnails may exclude the characteristic pages, and includes only the pages stored by the user in the second embodiment. As another example, the thumbnails may exclude the pages stored by the user in the second embodiment, and include only the characteristic pages.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The various modules of the systems described herein can be implemented as software applications, hardware and/or software modules, or components on one or more computers, such as servers. While the various modules are illustrated separately, they may share some or all of the same underlying logic or code. The accompanying claims and their equivalents are intended to cover such forms or modifications as would fall within the scope and spirit of the inventions.

What is claimed is:

1. An electronic device comprising:
a receiver configured to receive data of an electronic book comprising pages; and
a display controller configured to display a slider for designating one of pages in the electronic book, and to display a designated page in response to a designation by the slider,
wherein the display controller is configured to further display a first thumbnail in accordance with a first position corresponding to the first page on the slider, the first thumbnail comprising at least one of a part of first information, relating to the first page, included in a page of a table of contents and second information of an illustration of the first page or a page close to the first page.

2. The electronic device of claim 1, wherein
the first information comprises a mark configured to indicate the electronic book, and an icon displayed in association with the mark and configured to indicate a position of a displayed page, and
the mark is configured to be displayed in a different form for each chapter.

3. The electronic device of claim 2, wherein
the first information comprises a page number of the displayed page for each page of the electronic book.

4. The electronic device of claim 1, further comprising:
storage configured to store the first page by a first user operation; and
a display configured to display the first page, in response to a second user operation performed while a second page of the electronic book is displayed.

5. The electronic device of claim 1, wherein
the thumbnail comprises information of an illustration of a page that is close to the first page and has already been read.

6. A method for an electronic device comprising a receiver configured to receive data of an electronic book comprising pages, and a display controller configured to display a slider for designating one pages in the electronic book, and to display a designated page in response to a designation by the slider, the method comprising:
displaying a first thumbnail in accordance with a first position corresponding to the first page on the slider, the first thumbnail comprising at least one of a part of first information, relating to the first page, included in a page of a table of contents and second information of an illustration of the first page or a page close to the first page.

7. The method of claim 6, wherein
the first information comprises a mark configured to indicate the electronic book, and an icon displayed in association with the mark and configured to indicate a position of a displayed page, and
the mark is configured to be displayed in a different form for each chapter.

8. The method of claim 7, wherein
the first information comprises a page number of the displayed page for each page of the electronic book.

9. The method of claim 6, further comprising:
storage configured to store the first page by a first user operation; and
a display configured to display the first page, in response to a second user operation performed while a second page of the electronic book is displayed.

10. The method of claim 6, wherein the thumbnail comprises information of an illustration of a page that is close to the first page and has already been read.

11. A non-transitory computer-readable storage medium having stored thereon a computer program which is executable by a computer comprising a receiver configured to receive data of an electronic book comprising pages, and a display controller configured to display a slider for designating one of pages in the electronic book, and to display a designated page in response to a designation by the slider, the computer program comprising instructions capable of causing the computer to execute functions of:
displaying a first thumbnail in accordance with a first position corresponding to the first page on the slider, the first thumbnail comprising at least one of a part of first information relating to the first page, included in a page of a table of contents and second information of an illustration of the first page or a page close to the first page.

12. The storage medium of claim 11, wherein
the first information comprises a mark configured to indicate the electronic book, and an icon displayed in association with the mark and configured to indicate a position of a displayed page, and
the mark is configured to be displayed in a different form for each of chapters.

13. The storage medium of claim 12, wherein
the first information comprises a page number of the displayed page for each page of the electronic book.

14. The storage medium of claim 11, further comprising:
storage configured to store the first page by a first user operation; and
a display configured to display the first page, in response to a second user operation performed while a second page of the electronic book is displayed.

15. The storage medium of claim 11, wherein
the thumbnail comprises information of an illustration of a page that is close to the first page and has already been read.
